(19) United States
(12) Patent Application Publication
(10) Pub. No.: US 2010/0094578 A1
(43) Pub. Date: Apr. 15, 2010

(54) METHOD AND DEVICE FOR RECALIBRATING PRODUCTION PROCESSES

(76) Inventors: Thomas Schneider, Sandhausen (DE); Tomas Qvarfort, Rauenberg (DE)

Correspondence Address: COLLARD & ROE, P.C., 1077 NORTHERN BOULEVARD, ROSLYN, NY, 11576, US

(21) Appl. No.: 12/312,342

(22) PCT Filed: Oct. 8, 2007
(86) PCT No.: PCT/DE2007/001786

§ 371 Date: Oct. 30, 2009

(30) Foreign Application Priority Data
Nov. 7, 2006 (DE) 10 2006 052 673.2

(51) Int. Cl. G01N 21/35; G06F 19/00; G01J 3/28

(52) U.S. Cl. 702/84; 356/300

(57) ABSTRACT

Usually in automated production processes, new model ranges must be created and new calibrations carried out which may be costly, if a product is perfected or individual ingredients are exchanged. The aim of the invention is to simplify and also automate the recalibration. To achieve this, if there is a deviation from the product characteristics, a new calibration model is calculated, taking into consideration the modified ingredients. The process is modified as a result of the new calibration model in such a way that the model range that has been defined as the process objective is achieved again despite the modification of individual components.

The invention relates to a method and an apparatus for automated recalibration within the scope of determining the ingredients of a substance.

In product monitoring, a great measure of precision is frequently required in industry, whereby the influence variables of the production processes are frequently very difficult to influence. Specifically in the sector of foods production or pharmacy, it is necessary to adhere precisely to compositions of the products, so that constant monitoring of the products is carried out. For this purpose, model spectra are used as a basis for the production process, which are compared with the actual conditions during the course of production, within the scope of constant determinations of the ingredients. For this reason, it is necessary to keep the calibration models of the production process up to date at all times, in other words to make a corresponding change in the calibration model if individual ingredients are changed.

Now if the composition of a product, or even only one ingredient of a product, changes, the spectrum resulting from the product, which is preferably determined as a near infrared spectrum (NIR spectrum), also changes accordingly, so that a recalibration is required to produce a new calibration model, in order to regain the required product properties, in other words agreement with the model spectrum.

However, the production of a calibration model is connected with great effort; after all, in order to create a calibration model, usually first samples are taken, and these are analyzed in the laboratory, and afterwards, a new calibration is created, usually in multiple test series, with the goal of obtaining as similar a product as possible, despite the changed ingredients. In addition, the required samples are often not even available before the start of the production process. For individual deviations, time expenditures in the range of six hours must be expected, because of process-related waiting times within the scope of the analysis, and these can rapidly add up to several days as the result of deviations in different areas.

However, it is also known to pass the sample taken from the process to a computer system, which in turn calculates a calibration model. This application is subject to clearly lesser time expenditure, but represents an additional cost factor.

Because of the related costs and time expenditures, ways are being sought to automate the creation of new calibration models, which is usually very time-consuming.

Against this background, the present invention is based on the task of creating a method and an apparatus for automatic recalibration of a production process, which can do without sampling, and simplifies and automates the calculation of new calibration models.

This is achieved by means of the method for recalibrating a production process according to the characteristics of the main claim, as well as by the corresponding apparatus according to the characteristics of the secondary claim 14. Practical further developments of the method and of the apparatus can be derived from the dependent claims, in each instance.

According to the invention, a new calibration model for recalibrating a production process is obtained in that when the ingredients of the product change, a new composition, in other words a new process calibration, is determined on the basis of the known properties of the ingredients, in such a manner that the product to be expected agrees as extensively as possible, preferably completely, with the target default predetermined using model spectra. Within the scope of the production process, the product is monitored using spectrometers, which record spectra, preferably NIR spectra, of the product at individual points in time. In the case of a deviation of the ingredients from the composition recorded by the previous calibration, the spectrum of the product changes. From this change, it is determined, first of all, how the change in the ingredient affects the product. From knowledge of the system concerning the composition of the product and the properties of the ingredients, the system calculates a new calibration, on the basis of which the combination of the ingredients is changed in such a manner that at the end of the process, the desired product is produced once again, and the spectrum of the product agrees with the model spectrum once again. Because the recalibration according to the invention can also take place without taking samples and without laboratory calibrations, if necessary, and the use of uncoupled computer systems, the user is spared the costs and efforts of such samples, calibrations, and systems, at least in this case, and furthermore, at least extensively seamless continuation of the production process is made possible.

Every recording of a spectrum triggers a time stamp in the system, which allows replicating the composition of the product at a certain point in time. If, for example, the composition of the product is intentionally changed by replacing an ingredient, a time stamp is also applied to this change, so that the system can assign the change in the ingredients to the corresponding change in the spectrum. In conventional operation, as well, such time stamps are practical, in order to classify individual batches of a product in terms of time, and to be able to access products of the same batch, in targeted manner, in the case of defects or complaints.

A recalibration can advantageously be triggered manually if a change of one or more ingredients was made. Variations in the product composition can also occur during normal operation, as a result of the production conditions, whereby possibly a recalibration does not yet have to be carried out in the case of slight variations. However, if this is the case, nevertheless, possibly in the case of a slight but permanent change, the recalibration can be triggered by the personnel. Also, a time stamp is applied to the decisive point in time of the change, so that the system can recognize what change in the product composition is attributable to the desired change.

After calculation of the new calibration model, is it practical to allow the system, for example a control unit that can act on the production process, to intervene in the sequence automatically, so that the defaults of the new calibration model are immediately implemented precisely. In this connection, the new calibration model can furthermore be validated, in that the result is compared with the reference values and, if necessary, the calibration model is automatically corrected once again. In this form, a development of the automatic calibration model in multiple evolution steps is also possible.

Because the control of the production process can take place automatically, to a great extent, it is particularly practical that a database connected with the system is accessed to determine the properties of the changed ingredients. This database contains not only the model spectra, but also data sets concerning the ingredients of the product, which are required to calculate new calibration models, and to determine the effects of a change in individual ingredients.

In a practical further development of as automatic as possible a recording of the changed substance, it is also practical to automatically record the changed substance using spectrometers, particularly NIR spectrometers, and to also automatically feed the data obtained in this manner into the database.

It is particularly advantageous if recording of spectra of the product takes place at least approximately continuously, so that constant monitoring of the product, using spectrometers, preferably NIR spectrometers, is guaranteed. In the case of significant deviations, the system can trigger an alarm that informs the personnel of the production process of the deviation, i.e. that triggers a recalibration after a deviation brought about by an intentional change.

According to the invention, the system comprises a computer unit, which is used to calculate a new calibration model in the case of an intentional change of the product. For this purpose, the properties of the changed substance are taken into consideration, which can be determined from the comparison between the model spectrum and the deviating determined spectrum. In this connection, the computer unit accesses the data kept available in the database described above, as necessary. After the calculation of a new calibration model, this model is successively exchanged for the previous calibration model, while observing the spectrum, until the exchange is complete. In a first step, for this purpose, parts of the calibration calculated in this manner are first made the basis of the production process; after successful validation of this new calibration, the original calibration is replaced, until complete replacement has occurred. After each replacement step, the newly calculated calibration model is validated again, and if the validation is not successful, it is calculated again.

The invention described above will be explained in greater detail in the following, using an exemplary embodiment shown schematically in the drawing.

This shows:

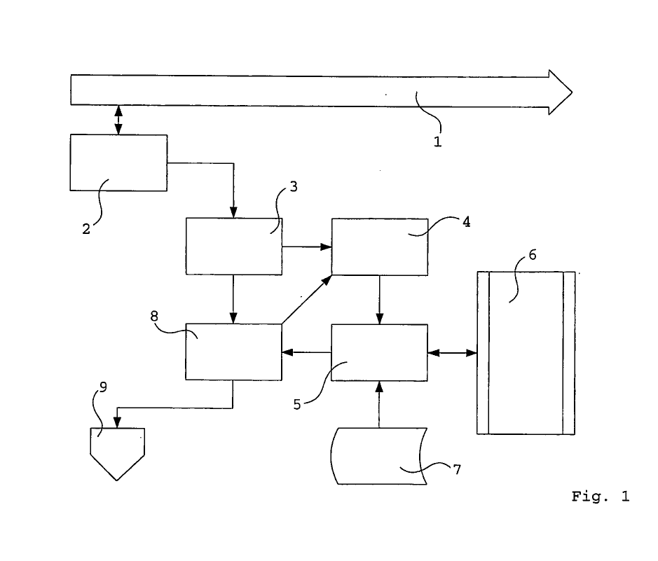

FIG. 1 the process of recalibration in a block schematic, and

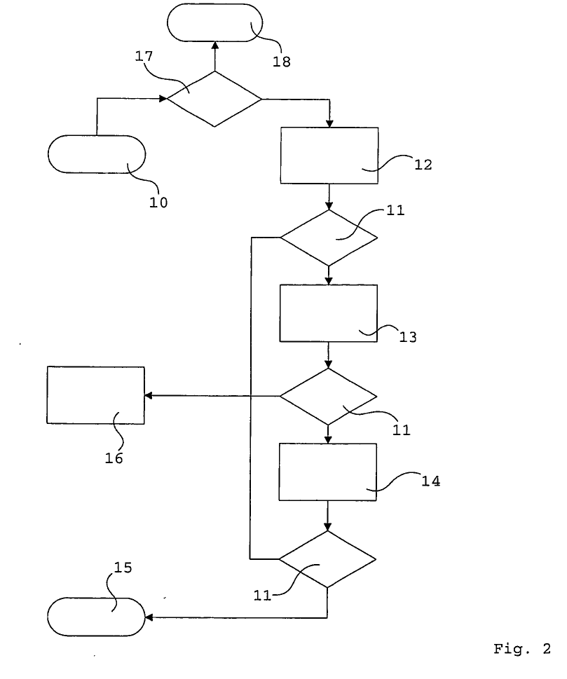

FIG. 2 the process of validation of a newly calculated calibration model.

FIG. 1 shows the progression of a recalibration process, in which first a sample measurement 3 of a product 1 is carried out using an NIR spectrometer 2. The properties of the product 1 are determined, and it is established whether there is a deviation from a model spectrum assigned to the product 1 as a reference. On the basis of the model spectrum, it is checked whether the product 1 is moving within the defaults of the production regulations for the product 1. If this is not true, it must be checked whether an intentional or unintentional deviation from the model spectrum is present. In the case of a deviation, the system will trigger an alarm, whereupon the user must determine whether or not the deviation is acceptable. In the case of an unacceptable deviation, intervention in the production process can take place. For a check whether or not an acceptable deviation is present, it is possible to access data kept available in the database 7. If this is an intentional deviation from the model spectrum, a message is sent to the system at the moment of the change, for example at the moment of the replacement of an ingredient with an ingredient that has been changed in comparison with the ingredient used until then. The changed ingredient or the changed concentration of the ingredient is entered into the system, i.e. into the database 7, manually or automatically.

If an intentional change is present, the properties of the substance 4 that characterize the change are given over to the system, or determined by the system, on the basis of the characteristics of the deviation of the spectrum from the model spectrum, and are taken into consideration in a new calibration model 5 that is to be calculated. For this purpose, the properties of the substance 4, the current calibration 8, and the required data from the database 7 are passed over to the computer unit 6, where the new calibration model 5 is first calculated, and subsequently, a validation is carried out.

The sequence of the validation of the newly calculated calibration model 5 is shown in FIG. 2, and will be explained in greater detail below.

If the new calibration 5 proves to be unusable, within the framework of the validation, a new calculation is carried out, again followed by a validation. As soon as the new calibration model 5 proves to be usable, within the framework of the validation, it is exchanged for the current calibration 8, and passed to the process 9.

FIG. 2 takes the aspect of validation out of the process described above. The validation of a new calibration model 5 is initiated by passing the calibration project 10 on to the computer unit 6. First, testing 12 takes place, whereby the new calibration model is used as a test data set, at first. If the validation is successful, testing with parts of the calibration 13 during trial operation is subsequently carried out, and the original calibration, again in the case of success, is completely replaced by the complete new calibration 14, within the framework of further testing. If the complete new calibration is also validated successfully, the new calibration 15 is taken over, and the production process is continued. If one of the aforementioned validations is not successful, this is followed by a new start of the calculation of the calibration 16, again followed by the complete validation process, in turn.

A method and an apparatus for calibrating a production process, in which a complicated recalibration by way of sampling and laboratory analysis, if a change in the ingredients occurs, can be eliminated, are therefore described above. This is achieved in that on the basis of the properties of the changed substance, which from the deviation of the spectrum and the model spectrum, taking into consideration the previous calibration model, a new calibration model is calculated, which is exchanged for the calibration model used up to that time, after careful validation.

### REFERENCE SYMBOL LIST

1 product

2 NIR spectrometer

3 sample measurement

4 properties of the substance

5 new calibration model

6 computer unit

7 database

8 current calibration

9 process

10 transfer of the calibration project

11 validation successful

12 testing as test data set

13 testing with parts of the new calibration

14 testing with the complete new calibration

15 take-over of new calibration

16 new start of calculation of the calibration

17 testing for deviations

18 no action

1-15. (canceled)

16. Method for recalibration, within the framework of determining the ingredients of a substance, as part of a production process, wherein the spectrum of a product (1) to be produced is monitored using at least one spectrometer, and, in case of a defined deviation of the spectrum of the product (1) from a model spectrum, in each instance, an automatic recalibration is undertaken, in such a manner that a new calibration model (5) is determined on the basis of the difference between the actual spectrum and the model spectrum, using a computer unit (6), in that a new calibration is calculated from knowledge concerning the composition of the product to be produced and the properties of the ingredients, in each instance, and in this way the spectrum is made to conform with the model spectrum.

17. Method according to claim 16, wherein a time stamp is assigned to the spectra determined over time, preferably to all of them.

18. Method according to claim 17, wherein the recalibration is triggered also manually, if necessary, whereby triggering of the recalibration is assigned to a time stamp.

19. Method according to claim 16, wherein automatic intervention in the method takes place by means of the new calibration model (5).

20. Method according to claim 16, wherein the product (1) is produced from one or more substances, and that within the scope of a recalibration, the properties of a changed substance (4) or multiple changed substances are derived from a database (7), to which the computer unit (6) has access.

21. Method according to claim 20, wherein the properties of the changed substance(s) are automatically recorded, particularly using spectrometers (2), and fed into the database (7).

22. Method according to claim 16, wherein the substances fed to the product (1) are continuously monitored using at least one spectrometer (2), and preferably, in the case of a deviation of the detected ingredients, trigger an alarm, at least a system-internal alarm.

23. Method according to claim 20, wherein a new calibration model (5) is calculated by the computer unit (6), on the basis of the properties of the changed substance (4), whereby the effects of the change on the current spectrum are taken into consideration on the basis of the properties of the changed substance (4).

24. Method according to claim 16, wherein after calculation of a new calibration model (5), this is successively taken over, i.e. at first taken over partially, then validated, and only after successful validation of this first part, an additional part is exchanged, etc., while observing the spectrum, until the exchange for the previous calibration is complete.

25. Method according to claim 24, wherein in the case that no further change of the calibration model has to take place, the calibration model is maintained.

26. Method according to claim 24, wherein the new calibration model (5) is validated after every exchange step (11, 12, 13), and the exchange is only continued in the case of a successful validation.

27. Method according to claim 26, wherein the exchange is stopped in the case of an unsuccessful validation, and renewed calculation of a new calibration model is started.

28. Method according to claim 16, wherein near infrared spectroscopy (NIR spectroscopy) is used to record the spectra.

29. Apparatus for recalibration, within the framework of determining the ingredients of a substance, as part of a production process, comprising at least one spectrometer (2) for recording a spectrum, preferably an NIR spectrum, of the product, at least one computer unit (6) for calculating calibration models, at least one database (7) for storing data about products (1) and/or product ingredients in memory, and at least one control unit for process control, whereby in the case of a defined deviation of the spectrum of the product (1) and/or individual product ingredients from a model spectrum, a recalibration can automatically be carried out by the computer unit (6), taking the properties of the product (1) and/or product ingredients into account, in that a new calibration is calculated, based on the knowledge of the composition of the product to be produced, and the properties of the ingredients, in each instance in such a manner that the deviation can be balanced out, and the new calibration model (5) calculated in this manner can be transferred to the control unit, for an exchange of the previous calibration model.
